(19) United States
(12) Patent Application Publication
(10) Pub. No.: US 2015/0157174 A1
(43) Pub. Date: Jun. 11, 2015

(54) GRILL REMOVAL TOOL WITH INTEGRATED KNUCKLE LOOP

(71) Applicant: Anthony Dawson Wilson, Riverside, IL (US)

(72) Inventor: Anthony Dawson Wilson, Riverside, IL (US)

(21) Appl. No.: 14/102,179

(22) Filed: Dec. 10, 2013

(51) Int. Cl. A47J 37/07; B65G 7/12

(52) U.S. Cl. CPC A47J 37/0786; B65G 7/12

(57) ABSTRACT

A grill removal tool with integrated knuckle handle loop that allows for the vertical application of force for removal of a barbeque grill has a loop handle with shoulder contours that extend to for arms with hooks at each end. The loop handle joins the two arms. The hooks are at the distal end of each arm. The hooked portions are the reaction element that is used to engage the barbeque grill during removal from or manipulation over a heat source. The basic concept is that the user is able to use the grill by placing the looped portion of the hook over their knuckle with a closed grip to allow or vertical removal of a barbeque grill with or without food present on the grill. The hooks are compatible with 100 percent of consumer grills on the market since the hooks are adequately fitted between spaces in grates.

### FIELD OF THE INVENTION

The present invention is generally related to devices, tools, or apparatuses designed for BBQ grill removal. In particular, in the areas of barbequing and outdoors cooking as a grill removal tool that provides for the safety of the user when using charcoal or propane grills of any size or shape. The present invention is directed to allow a user to remove a barbeque grill-cooking surface without being burned or further injured.

### BACKGROUND

One tool people have been using to remove grill is to use a grill lifter. The grill hooks are each located on one end of a continuous, solid rod while the handle joining the two hooks is located on the other end. Each hook end and accompanying handle is fixed. In order to operate or use, the user would need one hand to insert the hooks between grill bars and apply a downward force to engage the hooks on the grill before lifting the grill. When the grill lifter is in use, the users wrist must be supinated while applying downward leverage to engage the grill hooks with the grill grates.

Other tools teach, for example, a grill panel removal tool. Two separate grill hooks are fixed at each end of a rod, and fixed to the middle of the rod is a single handle that extends vertically with a 45-degree angle in its center, from the device. In order to operate or use, the user would need one hand to insert the hooks between grill spaces and apply a downward force to engage the hooks on the grill before lifting the grill. When the grill lifter is in use, the users wrist must be supinated while applying downward leverage to engage the grill hooks with the grill grates.

### SUMMARY OF THE INVENTION

In accordance with embodiments of the invention, aspects of the invention overcome deficiencies of prior tools by including an apparatus that is capable of lifting a BBQ grill from its base or enclosure without having to remove food from the surface of the grill. The device would allow the user to perform grill removal using the embodiments of the invention in a pair. For example, one embodiment of the invention would allow the user to quickly and safely lift a grill from a high flame and prevent foods from being burned or scorched with a tool in each hand of the user. The contact elements of the tool use the vertical or substantially vertical lifting force of the user to engage the grill. Using two hooking parts of the invention simultaneously as the preferred method, this allows the user to lift the grill with or without food on it away from a heat source without the danger of wrist injury. The device would be safe because it allows contact with the grill surface without exposing the user to risk of danger due to grill rotation during its movement. Also, the contact element of the grill hooks does not conduct heat, and avoids burn injury to the user.

According to one embodiment, a grill lifting apparatus includes a loop handle defining an open space for receiving a grasping member. The apparatus includes arms parallel to the loop handle. The apparatus also includes contoured shoulders joining two arms. The apparatus further includes a hook disposed at a distal each end of the arms. The apparatus also includes a contoured shoulder for connecting the other end of the arms and the loop handle. The contoured shoulder is substantially perpendicular to the arms and the loop handle.

According to another embodiment, an apparatus includes a handle defining an opening for accommodating a finger from a user. The apparatus includes two arms parallel to the handle. The apparatus further includes a hook disposed at one end of each of the two arms. The apparatus also includes a shoulder connector for connecting the other ends of the two arms and the handle. The shoulder connector is substantially perpendicular to the two arms and the handle.

According to a further embodiment, an apparatus includes a handle having a U shape. The handle defines an opening for accommodating a finger from a user. The apparatus includes arms parallel to the handle. The apparatus also includes a hook disposed at one end of each of the arms. The apparatus further includes a shoulder connector for connecting the other ends of the arms and the handle. The shoulder connector is substantially perpendicular to the arms and the handle.

### BRIEF DESCRIPTION OF THE DRAWINGS

The accompanying drawings, which are incorporated in and form a part of the specification, illustrate the embodiments of the present invention and, together with the description, serve to explain the principles of the invention in the drawings.

FIGS. 1 and 2 are perspective views of a grill lifting apparatus in accordance with one embodiment of the invention.

FIG. 3 is a side view of a grill lifting apparatus in accordance with one embodiment of the invention.

FIG. 4 is a front view of a grill lifting apparatus in accordance with one embodiment of the invention.

FIG. 5 is a rear view of a grill lifting apparatus in accordance with one embodiment of the invention.

FIGS. 6-8 are perspective views of a grill lifting apparatus in operation according to one embodiment of the invention.

Arrows show the length and measurements of this embodiment of the invention.

### DETAILED DESCRIPTION

The foregoing description of the invention is presented for purposes of illustration and description and is not intended to be exhaustive or limit the invention to the precise form disclosed, and obviously many modifications and variations are possible in light of the above teaching.

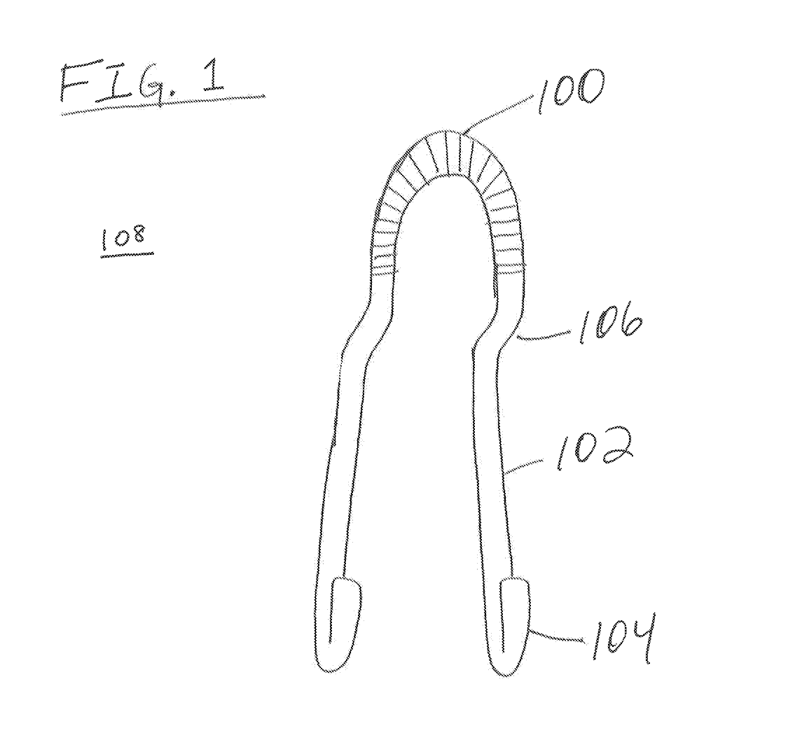

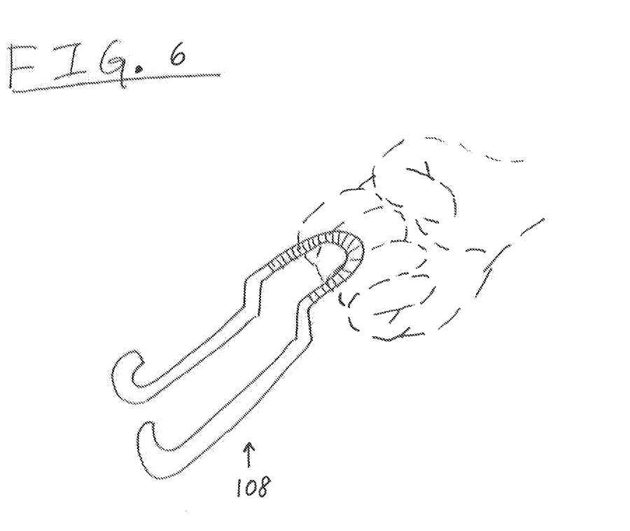

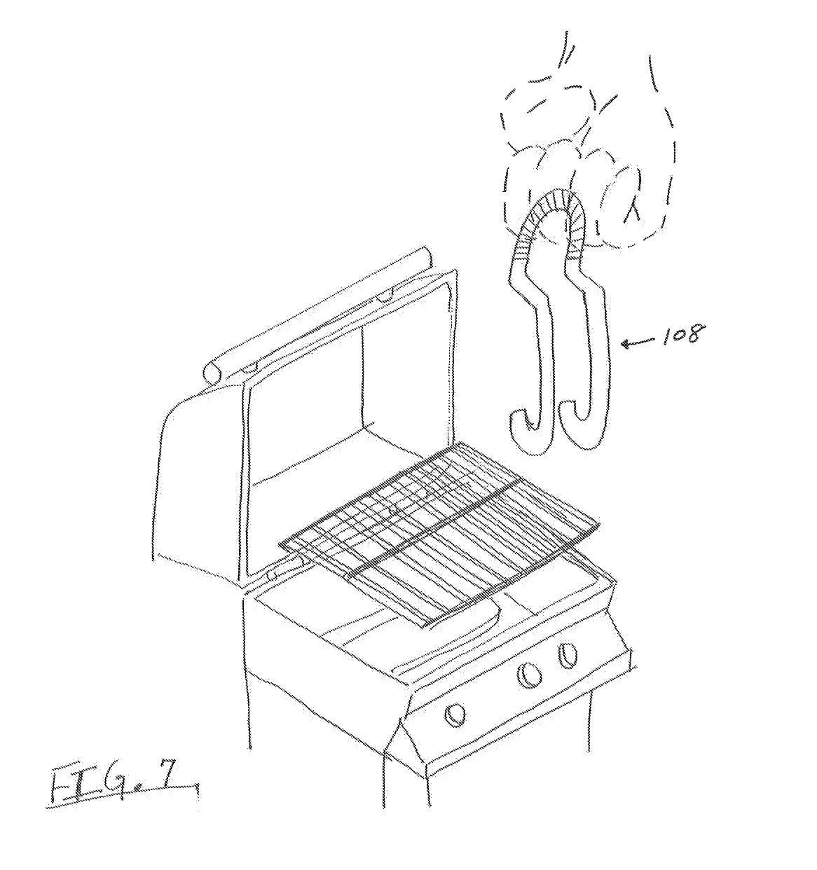

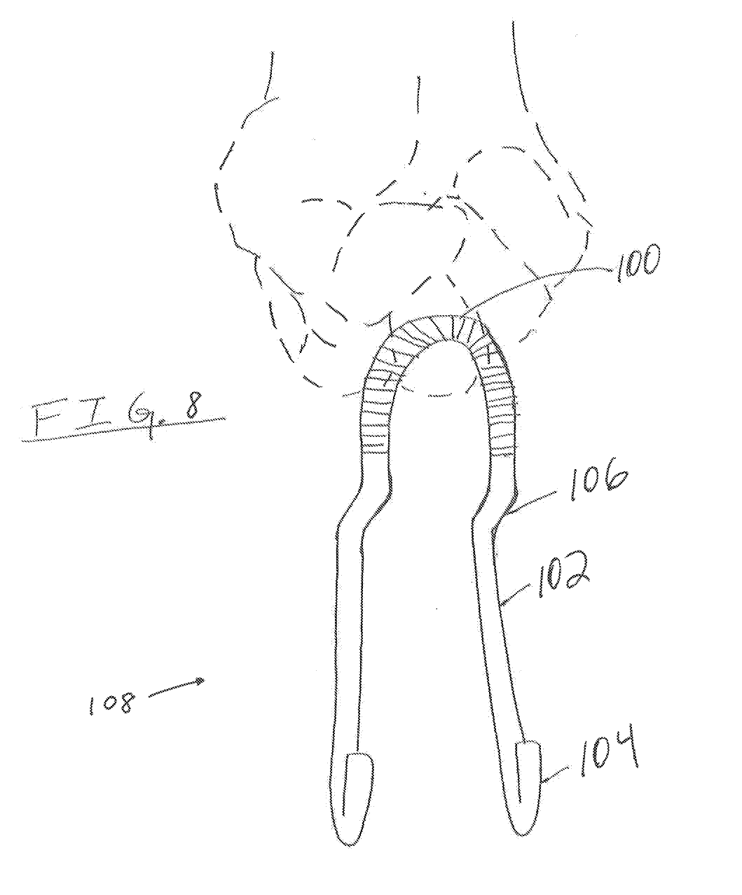

Referring to FIG. 1, a frontal view illustrates a grill lifting apparatus 108 in accordance with one embodiment of the invention. For example, the grill lifting apparatus 108 includes a handle 100, arms 102, a hook 104 at a distal end of each of the arms 102 and a contoured shoulder 106. In one example, the handle 100 is a looped shape or a “U” shaped. In another example, the handle 100 may be circular. In one example, the handle 100 is made of steel, preferably stainless steel, but can be made of brass, copper, aluminum, or any other material. In a further example, the handle 100 may also include a cover, a sleeve, a sheath, a cushion, or other known protective material. In another example, the cover of the handle 100 may possess poor heat conductivity property. In one example, the handle 102 is about 1 to 2 inches in length. The handle 100 also may define a space for accommodating a grasping member. For example, a user's finger or hand, as shown in FIGS. 6-8. In this construction, a curve portion of the handle 100 may have a diameter of 1 or more inches. It is understood that other length may be used without departing from the scope and spirit of the invention.

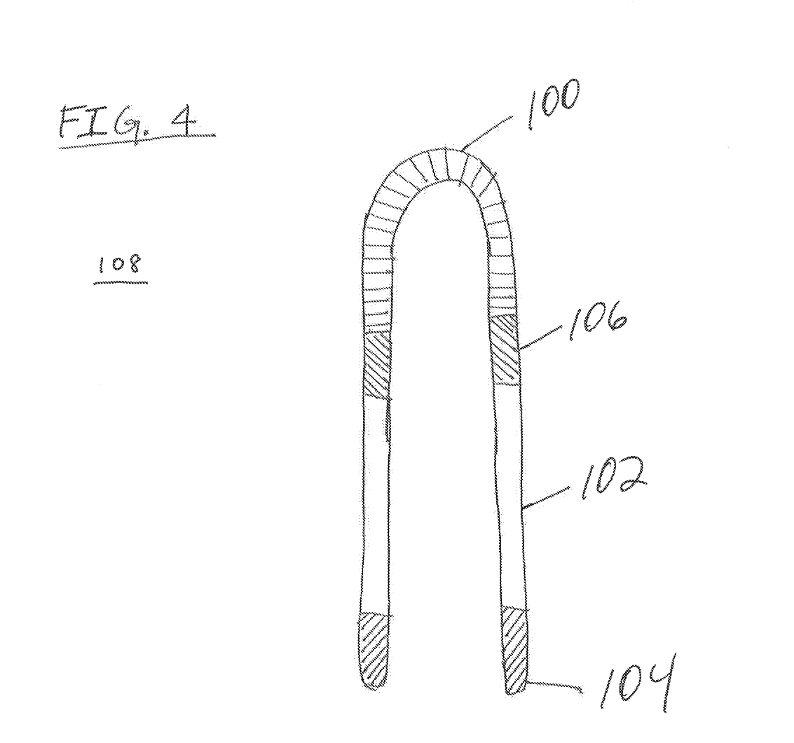

The arms 102 may be at least two in number. Each of the arms 102 may be made of stainless steel. In another embodiment, the arms 102 may be two or three. In this example, the arms 102 are about 3 or more inches in length when extending from the grasping member, for example a finger or hand (FIG. 4). Other lengths may be employed without departing from the scope or spirit of the invention. On the other hand, the length of the arms 102 does not exceed 10 inches long.

The apparatus 108 further includes a hook 104 at a distal end of each of the arms 102. For example, the hook 104 may be about 1 to 2 inches in length and may be made of steel, such as stainless steel. Other lengths of the hook 104 may be used without departing from the scope or spirit of the invention.

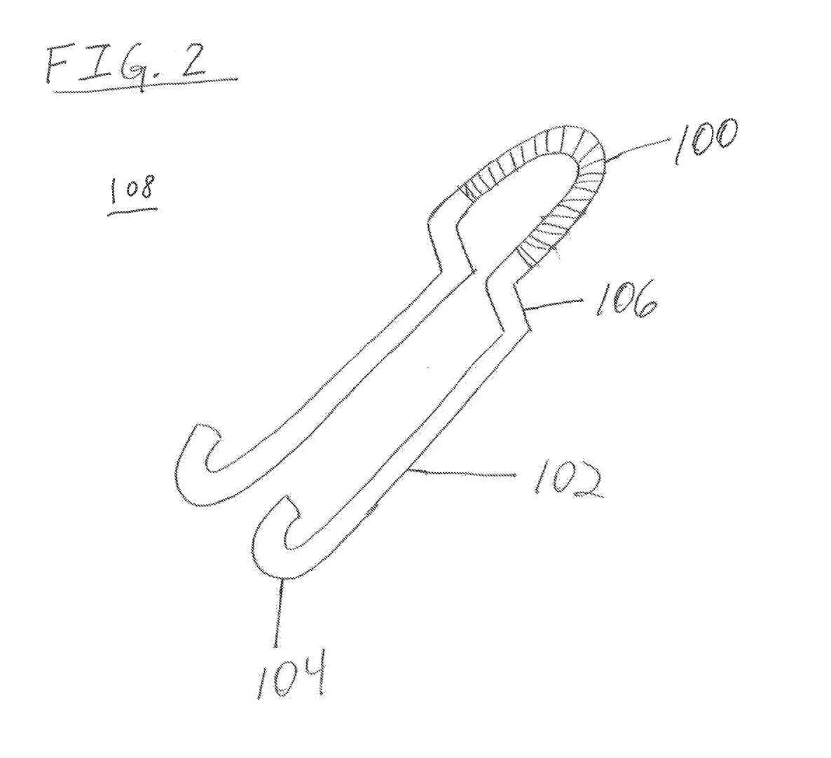

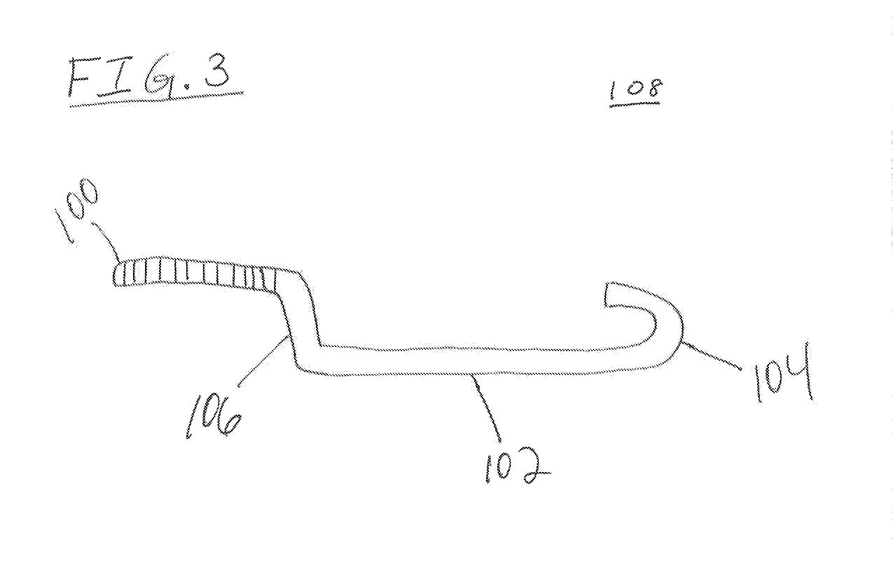

Still referring to FIG. 1, the apparatus 108 includes a contoured shoulder 106 for connecting the other end of the arms 102 and the handle 100. The contoured shoulder 106, creates a different plane between the handle 100 and the arms 102. The shoulder 106 consists of a first downward bend and second straight bend, creating a contoured, substantially 90-degree angle to create the shoulder 106. Unlike other prior art, which employ bends to allow for stabilization of the tool against the circumscribing grill border, grill grate, or adjacent tines. For example, the contoured shoulder 106 may be a shoulder connector and is substantially perpendicular to the arms 102 and the handle 100. For further illustration of the contoured shoulder 106, FIGS. 2-3 show different views of the contoured shoulder 106 comparing to the arms 102 and the handle 100. For example, FIG. 3 shows a side view of the apparatus 108. In this illustration, the arms 102 and the handle 100 are parallel to each other, but on a different plane. In this example, the contoured shoulder 106 connects the arms 102 and the handle 100 such that the contoured shoulder 106 is substantially perpendicular to the arms 102 and the handle 100. It is to be noted that the contoured shoulder 106 is also made of steel, such as stainless steel. In this way, the contoured shoulder 106 is inflexible and provides strength and rigidity to the apparatus 108.

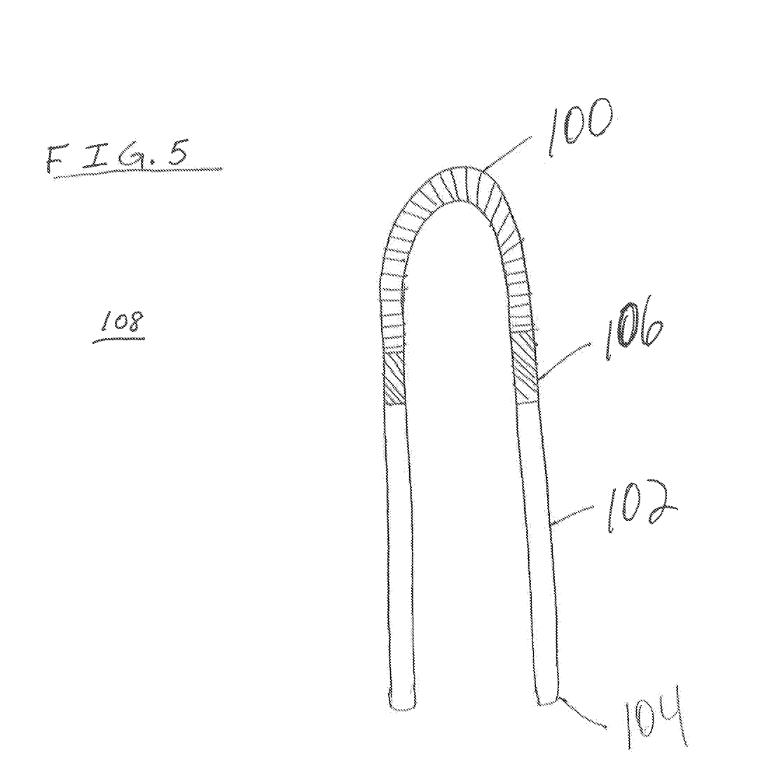

In another embodiment, referring to FIG. 4, a front view of the apparatus 108, and FIG. 5, a rear view of the apparatus 108, the width between the arms 104 at a connection point between the handle 100 and the contoured shoulder 106 is substantially the same as the width between the arms 102 at a connection point between the arms 102 and the hook 104. In another embodiment, the width between the arms 102 at a connection point between the handle 100 and the contoured shoulder 106 is smaller than the width between the arms 102 at a connection point between the arms 102 and the hook 104.

In a further example, the apparatus 108 is of a one-piece or an integrated design or construction. In another example, the loop joining both arms is coated to prevent slipping. For example, the handle loop may be covered in silicon. In another example, the handle loop may be covered with rubber.

In a further example, the apparatus 108 may include a two-piece design where the arms 102 are welded, screwed, or otherwise coupled together to the handle 100 on the one end and to the hook 104 on the other end. Further, the apparatus may be composed of various metals, such as steel, iron, copper, or brass. In a further example, any material that does not get burnt easily upon contacting the heated grill may be used as the above example is not exhaustive.

In operation, embodiments of the invention may be practiced as below:

A user would put one finger or two fingers (depending on the size of the fingers of the user) of a hand through the handle 100 to first engage the apparatus 108. The user would next use adjacent fingers or grasping members to firmly grasp or grab the handle 100. In some instances, the contoured shoulder 106 or the shoulder connector 108 is biased against or engages with knuckles of the user to firmly hold the apparatus 108. The user may similarly use the other hand to operate another apparatus 108. Next, the user would bring the apparatus 108 above a grill that is to be removed. Grill grates vary in shape, size, and have varying spaces between grill tines. However, the grill hook apparatus 108 may be used with any grill as it can easily be placed between the tines of any standard grill grate. The user would first insert the apparatus 108 between the grill tines such that the hook 104 of each of the arms 102 engages with one of the tines. Once the hook 104 is engaged, the user would apply a vertical force to lift the grill without the danger of wrist injury due to grill weight or rotation while using one single tool.

This embodiment of the invention also includes a method of using two grill hooks, one in each hand, allowing the user to vertically move the grill away from a heat source without forcing the user to augment the natural movement of the wrist to engage the grill hook with leverage in order to move the grill. The grill may be easily placed on a stand or somewhere away from the user. According to this embodiment of the invention, a user may use two of the apparatus simultaneously to allow the user prevent grill rotation during movement, therefore preventing wrist injury. Furthermore, the shoulders 106 of the apparatus 108 do not make contact with the grill tines or any portion of the grill, the only contact points are the hooks 104 with the grill tines to allow for vertical lift. For example, the shoulders 106 do not touch any of the grill tines or any part of the grill. Unlike some of the prior art, the grill hooks apparatus 108 may be inserted at any part of the grill between the tines, not just at the circumscribing border or peripheral portion of the grill.

The user only needs to hold the grill hooks around their fingers to operate the grill hooks, one in each hand to safely move the grill without grill rotation, not a single tool that uses leverage to engage the grill with contact elements, exposing the user to wrist injury. Further, the shoulders of the embodiment of the invention align the arms of the invention with the users hand to create stability when the hooks are engaged with the barbeque grill or its tines, as the shoulders help to maintain a straight line extension of the arms with the user's hand while the grill hooks are engaged with the barbeque grill.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A grill lifting apparatus comprising:
a loop handle defining an open space for receiving a grasping member;
arms parallel to the loop handle;
a hook disposed at a distal end of the arms; and
a contoured shoulder for connecting the other end of the arms and the loop handle, said contoured shoulder being substantially perpendicular to the arms and the loop handle.

2. The grill lifting apparatus of claim 1, wherein the loop handle, the arms, the hook, and the contoured shoulder being composed as a one-piece structure.

3. The grill lifting apparatus of claim 1, wherein the loop handle further comprising a sleeve.

4. The grill lifting apparatus of claim 1, wherein the arms comprise two arms.

5. The grill lifting apparatus of claim 1, wherein each of the arms comprises a length of 3 or more inches.

6. The grill lifting apparatus of claim 1, wherein the loop handle comprises a diameter length of 1 or more inches for a loop portion of the loop handle.

7. An apparatus comprising:
A handle defining an opening for accommodating a finger from a user;
two arms parallel to the handle;
a hook disposed at one end of each of the two arms; and
a shoulder connector for connecting the other ends of the two arms and the handle, said shoulder connector being substantially perpendicular to the two arms and the handle.

8. The apparatus of claim 7, wherein the handle, the two arms, the hook, and the contoured shoulder being composed as a one-piece structure.

9. The apparatus of claim 7, wherein the handle further comprising a sleeve.

10. The apparatus of claim 7, wherein each of the two arms comprises a length of 3 or more inches.

11. The apparatus of claim 7, wherein the handle comprises a diameter length of 1 or more inches for a loop portion of the loop handle.

12. The apparatus of claim 7, wherein the two arms are on a separate plane as the handle.

13. The apparatus of claim 7, wherein the shoulder connector being adapted for engaging areas near metacarpal joints of the hand of the user.

14. An apparatus comprising:
A handle having a U shape, said handle defining an opening for accommodating a finger from a user;
arms parallel to the handle;
a hook disposed at one end of each of the arms; and
a shoulder connector for connecting the other ends of the arms and the handle, said shoulder connector being substantially perpendicular to the arms and the handle.

15. The apparatus of claim 14, wherein the handle, the two arms, the hook, and the contoured shoulder being composed as a one-piece structure.

16. The apparatus of claim 14, wherein the handle further comprising a sleeve.

17. The apparatus of claim 14, wherein each of the two arms comprises a length of 3 or more inches.

18. The apparatus of claim 14, wherein the handle comprises a diameter length of 1 or more inches for a loop portion of the loop handle.

19. The apparatus of claim 14, wherein the arms being on a separate plane as the handle.

20. The apparatus of claim 14, wherein the shoulder connector being adapted for engaging areas near metacarpal joints of a hand of the user.
